(19) United States
(12) Patent Application Publication
(10) Pub. No.: US 2017/0113709 A1
(43) Pub. Date: Apr. 27, 2017

(54) CLIPABLE MODULAR CARTS FOR TRANSPORTING DEVICES AND METHODS OF USE

(71) Applicant: MASON TARGET SYSTEMS, LLC, San Francisco, CA (US)

(72) Inventor: Gregory T. MASON, San Francisco, CA (US)

(21) Appl. No.: 15/299,062

(22) Filed: Oct. 20, 2016

Related U.S. Application Data
(60) Provisional application No. 62/244,960, filed on Oct. 22, 2015.

(51) Int. Cl. B62B 1/10

(52) U.S. Cl. CPC B62B 1/10; B62B 2206/003

(57) ABSTRACT

A clipable modular cart is disclosed. The clipable modular cart has two components: a handle component which removably engages a first section of a device to be moved; and a wheel component which removably engages a second section of a device, different than the first section. Also disclosed are methods of using the clipable modular cart.

### CROSS-REFERENCE

This application claims the benefit of U.S. Provisional Application No. 62/244,960, filed Oct. 22, 2015, entitled CLIPABLE CARTS FOR TRANSPORTING DEVICE AND METHODS which application is incorporated herein by reference.

### BACKGROUND

Hand trucks have many forms. Utility hand trucks typically have a flat protruding plate that can be slipped under a box or other heavy object. The plate is connected to a vertical framework. The vertical framework is supported by two wheels. This configuration allows an object to be lifted, typically when it is strapped to the vertical framework. The vertical framework is then tilted backward out of the vertical plane. Leverage is transferred to the plate under the object and the object lifts off the ground. Once the weight has shifted, the weight of the object is borne by the wheels of the hand truck. The object can therefore be moved by rolling the hand truck.

In some situations, moving an object via a hand truck is not convenient. A need therefore exists for system that engages a planar object to facilitate movement without having to place that object on the blade of a handcart. These needs are met by the present disclosure.

### SUMMARY

Disclosed is a clip-on cart system, or modular hand truck, for which are used to convert a large, heavy objects into a transportable, movably object. The system has features selected from the following: removability; clipable onto existing features of a device; attachable with minimal effort. The system converts a device into a portable device without permanently altering the device. The components of the system are configurable to engage two sides of the device wherein the two sides can be opposing sides.

An aspect of the disclosure is directed to a modular clip-on hand cart. The modular clip-on cart comprises: a handle module, or drawbar, having two elongated side members with a first end cross member, a second end cross member and a connector for engaging a device to be transported; a wheel assembly module having a first wheel and a first wheel vertical connector, a second wheel and a second wheel vertical connector and a transverse member connecting the first wheel to the second wheel along an axis, wherein the handle engages a device to be transported at a first side and the wheel assembly module engages the device to be transported at a second side, and further wherein the handle does not directly engage the wheel assembly module. In some configurations, the handle module connector is a hook at a device engaging end of the handle module. The first end cross member can have a pin which secures the device to be transported against a portion of the two elongated side members. The second end cross member can also be configured to have a handle extending therefrom. In at least some configurations, the wheel assembly has a first latch which engages the device to be transported adjacent the first wheel and a second latch which engages the device to be transported adjacent the second wheel. Additionally, the handle module engages the device to be transported on a first side and the wheel assembly engages the device to be transported on a second side opposite the first side.

Another aspect of the disclosure is directed to a method of transporting a device comprising: engaging a device to be transported on a first side with a handle module having two elongated side members with a first end cross member, a second end cross member and a connector for engaging the device to be transported; securing the handle module to the device to be transported; engaging the device to be transported on a second side with a wheel assembly module having a first wheel and a first wheel vertical connector, a second wheel and a second wheel vertical connector and a transverse member connecting the first wheel to the second wheel along an axis; and securing the wheel assembly to the device to be transported. Additionally, the method can comprise lifting a portion of the device to be transported by the handle. In some configurations, the step of engaging the device to be transported to a handle module includes rotating a clip to secure a portion of the device to be transported against a surface of the two side members. Additionally, the step of engaging the device to be transported to the wheel assembly can include latching the wheel assembly to secure a portion of the device to be transported against a transverse member connecting the first wheel to the second wheel along an axis.

Still another aspect of the disclosure is directed to a kit comprising: a modular clip-on hand cart comprising a handle module having two elongated side members with a first end cross member, a second end cross member and a connector for engaging a device to be transported; a wheel assembly module having a first wheel and a first wheel vertical connector, a second wheel and a second wheel vertical connector and a transverse member connecting the first wheel to the second wheel along an axis, wherein the handle engages a device to be transported at a first side and the wheel assembly module engages the device to be transported at a second side, and further wherein the handle does not directly engage the wheel assembly module; and a steel target formed from a plate of armor grade steel having a first side and a second side, at least one target stand configurable to engage the at least one steel target, at least one transceiver positioned proximate to the at least one steel target and in wireless communication with the at least one steel target, and a plurality of vibration sensors positioned on the second side of the steel target wherein the plurality of vibration sensors detect a vibration data from a kinetic energy transferred from a projectile which impacts the first side of the steel target without penetration and wherein the plurality of sensors detect the vibration data from the second side of the steel target and further wherein the plurality of vibration sensors communicate the detected vibration data to the transceiver.

Another aspect of the disclosure is directed to a modular clip-on hand cart comprising: a handle module means having two elongated side member means with a first end cross member means, a second end cross member means and a connector for engaging a device to be transported; a wheel assembly module means having a first wheel and a first wheel vertical connector, a second wheel and a second wheel vertical connector and a transverse member connecting the first wheel to the second wheel along an axis, wherein the handle engages a device to be transported at a first side and the wheel assembly module means engages the device to be transported at a second side, and further wherein the handle does not directly engage the wheel assembly module means. The handle module means connector can be a hook means at a device engaging end of the handle module means. The first end cross member means has a pin means which secures the device to be transported against a portion of the two elongated side member means. The second end cross member means can be configured to a handle means extending therefrom. The wheel assembly can be configured with a first latch means which engages the device to be transported adjacent the first wheel and a second latch means which engages the device to be transported adjacent the second wheel. Additionally, the handle module means can be configured to engage the device to be transported on a first side and the wheel assembly means engages the device to be transported on a second side opposite the first side.

Still another aspect of the disclosure is directed to a method of transporting a device comprising: engaging a device to be transported on a first side with a handle module means having two elongated side member means with a first end cross member means, a second end cross member means and a connector for engaging the device to be transported; securing the handle module means to the device to be transported; engaging the device to be transported on a second side with a wheel assembly module means having a first wheel and a first wheel vertical connector, a second wheel and a second wheel vertical connector and a transverse member connecting the first wheel to the second wheel along an axis; and securing the wheel assembly to the device to be transported. Additionally the method can include lifting a portion of the device to be transported by the handle means. Additionally, the step of engaging the device to be transported to a handle module means can include rotating a clip to secure a portion of the device to be transported against a surface of the two side members. The step of engaging the device to be transported to the wheel assembly can further include latching the wheel assembly to secure a portion of the device to be transported against a transverse member connecting the first wheel to the second wheel along an axis.

### INCORPORATION BY REFERENCE

All publications, patents, and patent applications mentioned in this specification are herein incorporated by reference to the same extent as if each individual publication, patent, or patent application was specifically and individually indicated to be incorporated by reference. See, for example, U.S. Pat. No. 9,156,485 B1 to McLardy issued Oct. 13, 2015, for Leverage Cart Assembly; U.S. Pat. No. 9,156,319 B1 to Kennemer et al. issued Oct. 13, 2015 for Quick Change Dual Purpose Draw Bar; U.S. Pat. No. 9,126,611 B1 to Liu issued Sep. 8, 2015 for Handcart; U.S. Pat. No. 8,465,046 B2 to Meyers et al. issued Jun. 18, 2013 for Convertible Hand Truck; U.S. Pat. No. 4,009,891 A to Jensen issued Mar. 1, 1977 for Hand Trucks; U.S. Pat. No. 2,787,478 A to Schmidt issued Apr. 6, 1956 for Handle Control For Tongue Hitch Drop Pin.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A is a perspective view of a clip-on cart system which has a device to be transported thereon;

FIG. 1B is a close-up perspective view of the clip-on cart system engaging a lateral bar of the device to be transported;

FIG. 2 is a perspective view of the handle module of the clip-on cart system;

FIGS. 3A-D depict the steps of engaging the handle module of the clip-on cart system with a lateral bar of the device to be transported;

FIGS. 4A-E illustrate the steps of engaging the wheel assembly module of the clip-on cart system with a device to be transported; and

FIGS. 5A-F illustrate additional views of the clip-on cart system engaging a device to be transported.

### DETAILED DESCRIPTION

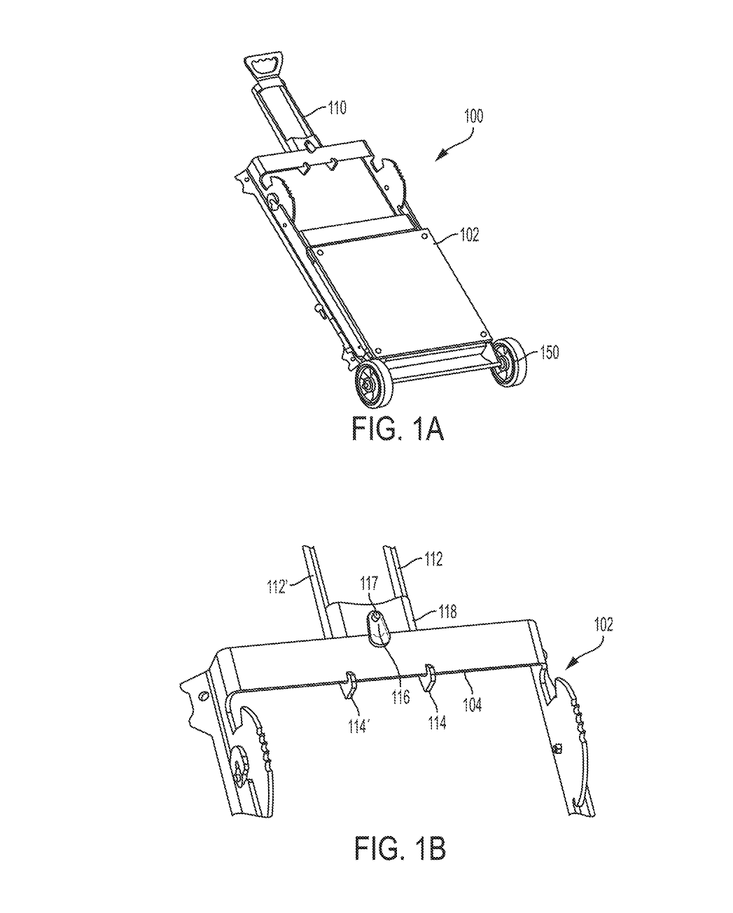

FIG. 1A is a perspective view of a clip-on cart system 100 which is engaging a device 102 to be transported (e.g., a planar device as illustrated) wherein the clip-on cart system 100 and the device 102 are ready for transportation. The clip-on cart system 100 is modular with a handle module 110, or drawbar, and a separate wheel assembly module 150. The modular components are configurable to engage an object at different locations of the device 102. The clip-on cart system 100 is particularly suitable for engaging a device 102 having a size exceeding 18″×18″. The device to be transported may be round, square, rectangular, elliptical, ovoid, or any other shape. The clip-on cart system 100 can be made from, for example, 0.25″ A36 Steel plate—which is a standard steel alloy used for structural steel. The clip-on cart system 100 is configured for easy application and removal and can clip-on to existing structural features of a device 102, such as a lateral bar or mounting holes. Both the handle module 110 and wheel assembly module 150 clip-onto the frame of the device 102 to be transported and mechanically lock onto the device 102 to prevent the device 102 from moving or bouncing off the cart when the device 102 is pulled over rough terrain or across elevation changes. As will be appreciated by those skilled in the art, the handle module 110 and the wheel assembly module 150 can engage opposing sides of the target device to be transported when deployed, or in some configurations, adjacent sides.

The device to be transported 102 can be, for example, a steel target formed from a plate of armor grade steel having a first side and a second side, at least one target stand configurable to engage the at least one steel target, at least one transceiver positioned proximate to the at least one steel target and in wireless communication with the at least one steel target, and a plurality of vibration sensors positioned on the second side of the steel target wherein the plurality of vibration sensors detect a vibration data from a kinetic energy transferred from a projectile which impacts the first side of the steel target without penetration and wherein the plurality of sensors detect the vibration data from the second side of the steel target and further wherein the plurality of vibration sensors communicate the detected vibration data to the transceiver. See, US 2016/0091285 A1 to Mason published Mar. 21, 2016.

FIG. 1B is a close-up perspective view of the handle module 110 of the clip-on cart system engaging a lateral bar 104 of the device 102 to be transported. The handle module 110 has two side members 112, 112′ that are parallel, or substantially parallel, elongated bars having a length, width and thickness. The two side members 112, 112′ as illustrated have thinnest portion facing upward and the widest portion facing each other on one side respectively. A cross member 118 connects the two side members 112, 112′ at or near a first end which is distal to a user during operation. The cross-member can be integrally formed with the two side members 112, 112′ or a separate member adhered to the two side members. The cross member 118 has a clip 116 which rotates about a pin 117 to engage the lateral bar 104 of the device 102 in a secured arrangement when the handle module 110 is deployed. The clip 116 can be positioned on the upward facing side of the handle module 110.

The two side members 112, 112′ each further include a hook 114, 114′ which is configured to engage the lateral bar 104. The hook 114, 114′ can be u-shaped or square shaped to snugly engage the lateral bar 104 within the hooks during deployment. The width of the u-shaped hook can have a width, for example, that receives the thickness of the lateral bar 104 so that when the lateral bar 104 is positioned within the hook 114, 114′ the lateral bar 104 fits securely. The width between the two side members 112, 112′ is from 3 inches to 12 inches, more preferably 4 inches to 6 inches; and the length of the side members 112, 112′ is from 12 inches to 48 inches, more preferably 18 inches to 36 inches. As will be appreciated by those skilled in the art, the width is selected to avoid unnecessary rotational movement of the device 102 when the handle module 110 is attached during transport and the length is selected to provide adequate height for a user to deploy without bending over.

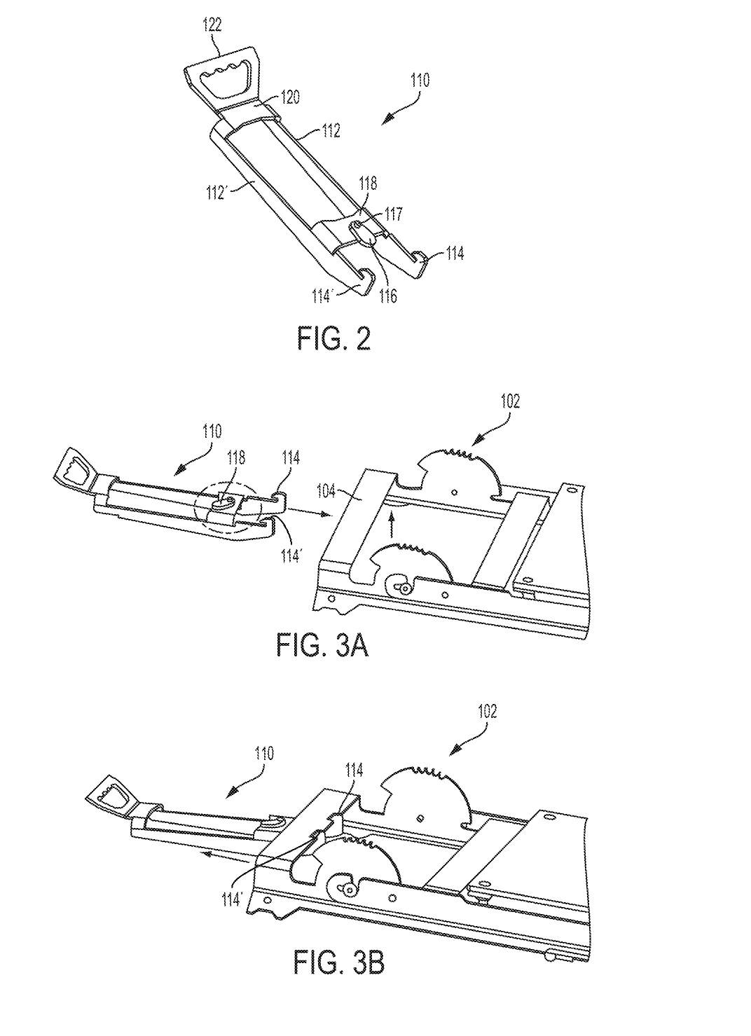

FIG. 2 is a perspective view of the handle module 110 of the modular clip-on cart system. The handle module 110 can be formed from a single piece of A36 Steel plate and feature a main body with a clip 116, which can be a gravity engaging teardrop clip, is secured to the body of the handle module via a pin 117. As described above, two side members 112, 112′ are provided which have hooks 114, 114′ at a device engaging end and a handle 122 at another end. A second cross member 120 can be provided which is proximal to the first cross member 118 and functions as a handle or which provides a handle member 122. The handle member 122 can be formed with a through cavity for insertion of a user's hand. The handle (either the second cross-member or the handle member 122) can further have a scalloped surface which fits the curves of the fingers of a user's hand when engaged. Additionally, the handle member 122 is illustrated as extending from the second cross member 120 at an angle. However, in other configurations, the handle member 122 can be rotatably connected to the second cross member 120 so that the handle 122 can be, for example, folded towards the second cross-member 120, or rotated about a longitudinal axis formed by the two side members 112, 112′.

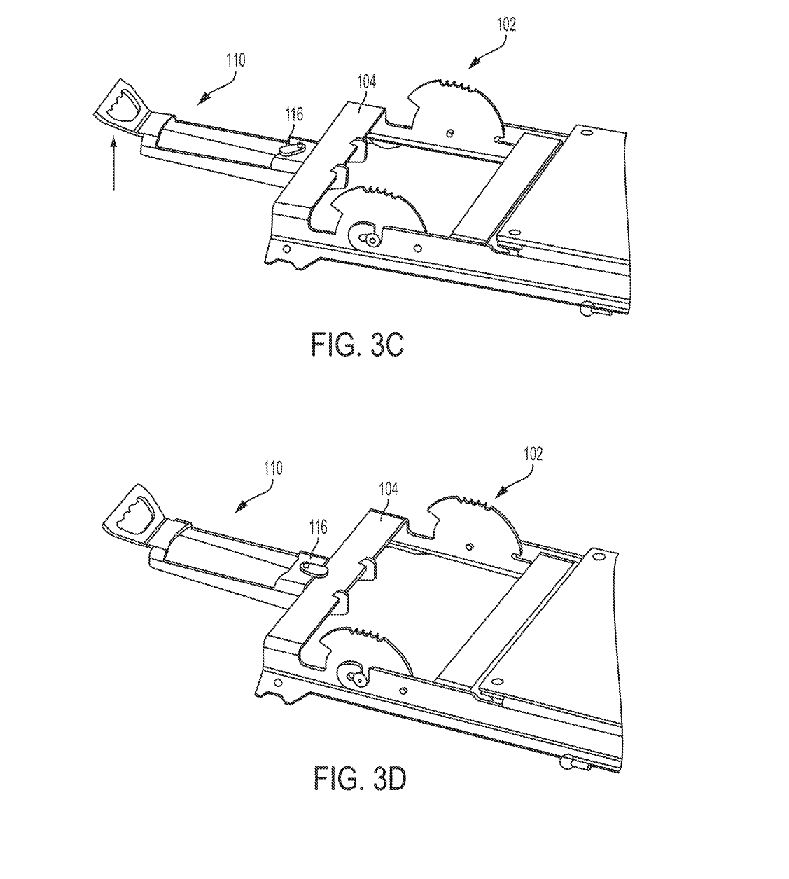

FIGS. 3A-D depict the steps of engaging the handle module 110 of the modular clip-on cart system with a lateral bar 104 of the device 102 to be transported. As shown, the handle module 110 engages the device 102 from under a cross beam. The clip 116 is rotated towards the handle 122. The handle module 110 is then brought under the device and lifted upward resulting in the engagement illustrated in FIG. 3B after the notched end clears the lateral bar 104. Once the lateral bar 104 is nested within the hooks 114, 114′ the clip 116 is rotated to secure the lateral bar 104 within the hooks. Once engaged, when the handle and device are lifted, the clip or latch can be configured to automatically rotate into place securing the handle to the device. Consequently, the handle would only be removable upon physically rotating the clip 116 out of the way. This provides an additional measure of security for the system during operation or while deployed.

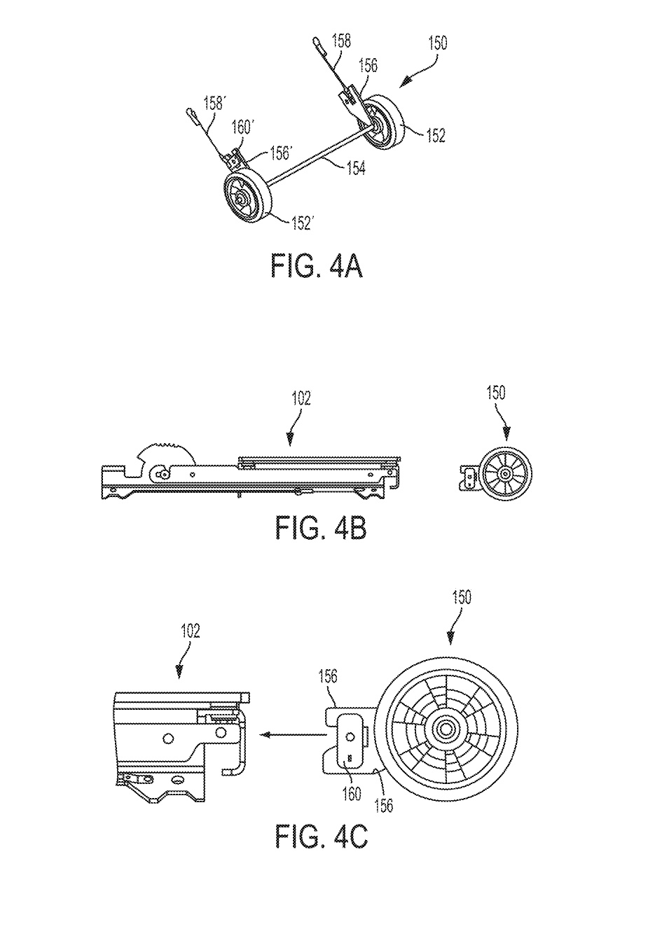

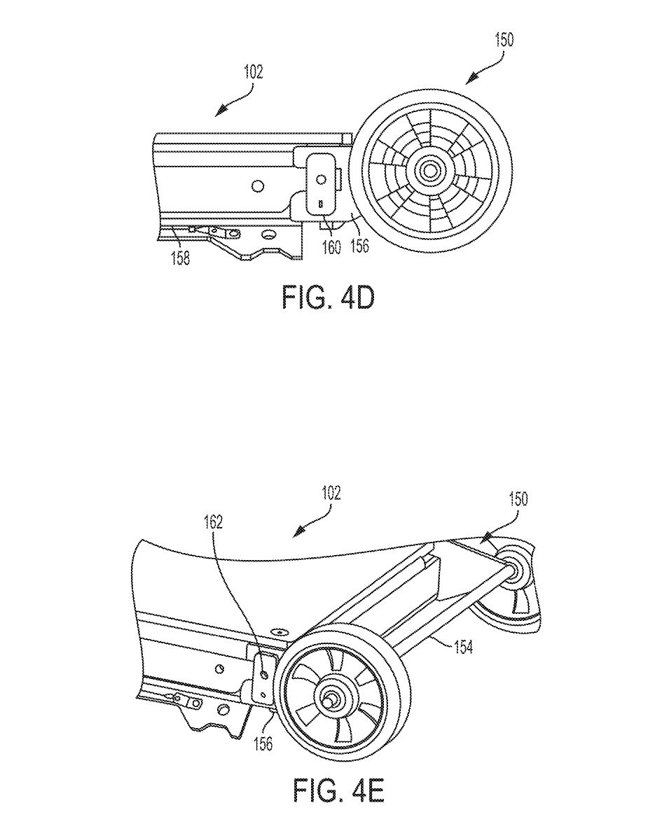

FIGS. 4A-E illustrate the steps of engaging the wheel portion of the modular clip-on cart system with a device 102. The wheel assembly module 150 has two or more wheels 152, 152′ which are positioned along a transverse member 154 or wheel shaft. In some configurations, for example where two wheels are used, the wheels can be positioned at either end of the transverse member as shown. Additionally, the wheels can be cantilevered to provide additional stability such that the wheels are not completely perpendicular to the transverse member 154. A vertical connector 156, 156′ is provided from each of the wheels 152, 152′ which is connected to a lanyard 158, 158′. With the device 102 in a horizontal position, the wheel assembly module 150 is positioned adjacent the device 102 as shown in FIGS. 4B-C. The wheel assembly module 150 is then moved towards the device 102. The vertical connector 156 is attached and engages the device 102 to be transported and a latch 160 engages the device. The latch 160 can be rotatable. The lanyard 158 with attached pins is pushed through a ⅜″ aperture 162 on either side of the device 102 frame prong. The lanyard 158 is connected to the device 102 to secure the wheel assembly module 150 to the device 102. The wheel assembly module 150 has a base that can be removed when the pins are removed from the wheel base assembly. In one embodiment, a ½″ diameter transverse member 154 of the wheel assembly module can also be used as a handle on very rough terrain or when loading or unloading from a vehicle or trailer.

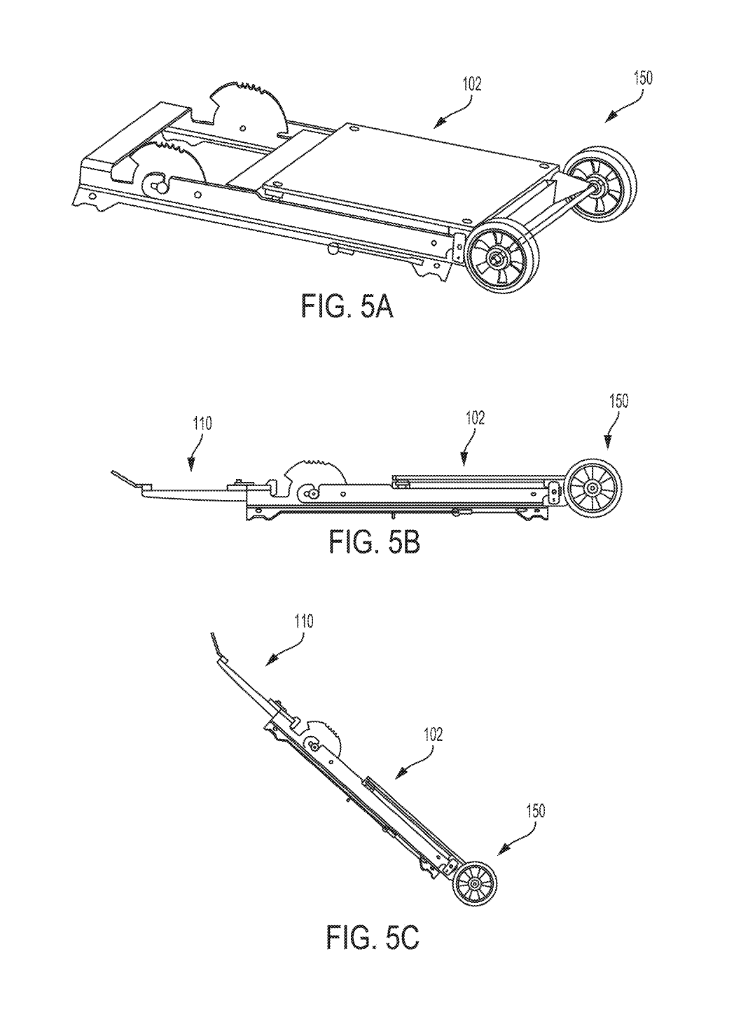

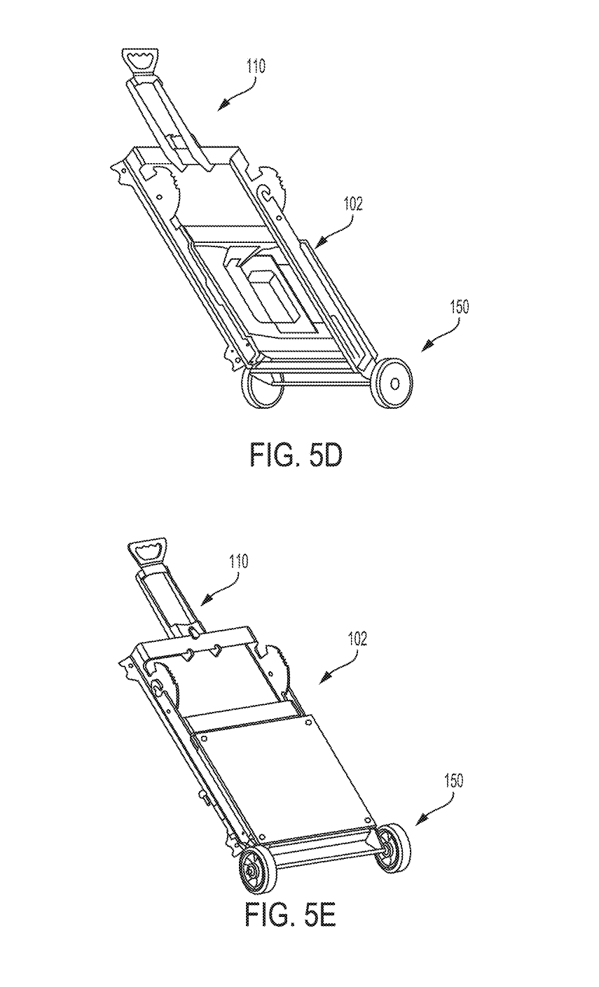

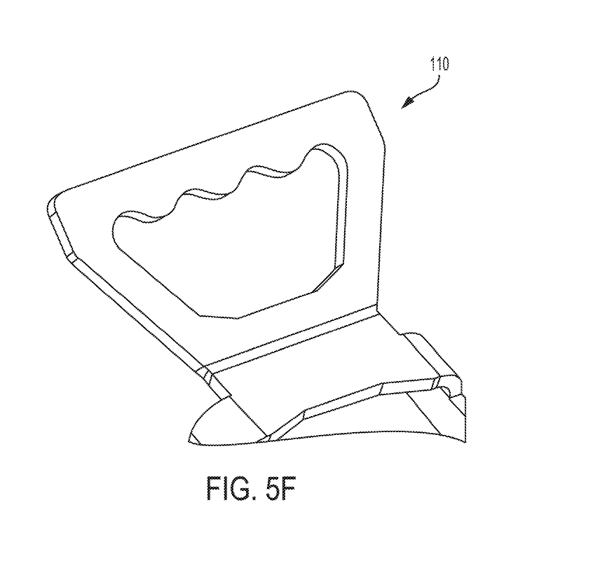

FIGS. 5A-F illustrate additional views of the modular clip-on cart system engaging a device 102 to be transported. Both the handle module 110 and the wheel assembly module 150 can be attached to the device 102 to be transported when the device 102 is in, for example, a stowed configuration. Heavy lifting is not required to get the device 102 attached or detached to the modular clipable cart assembly components. Once the handle and wheel base are attached, as shown in FIG. 5B, the entire assembly can be rotated for transportation so that the wheels are on the ground and the handle is positioned to be in the hand of a user, as shown in FIG. 5C. FIG. 5F illustrates additional detail about the handle module 110 showing a cut-out with grooves to accommodate a user's fingers when the handle is grasped.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A modular clip-on hand cart comprising:
a drawbar having two elongated side members with a first end cross member, a second end cross member and a connector for engaging a device to be transported;
a wheel assembly module having a first wheel and a first wheel vertical connector, a second wheel and a second wheel vertical connector and a transverse member connecting the first wheel to the second wheel along an axis,
wherein the drawbar engages the device to be transported at a first side and the wheel assembly module engages the device to be transported at a second side, and further wherein the drawbar does not directly engage the wheel assembly module.

2. The modular clip-on hand cart of claim 1 wherein the drawbar connector is a hook at a device engaging end of the drawbar.

3. The modular clip-on hand cart of claim 1 wherein the first end cross member has a pin which secures the device to be transported against a portion of the two elongated side members.

4. The modular clip-on hand cart of claim 1 wherein the second end cross member has a handle extending therefrom.

5. The modular clip-on hand cart of claim 1 wherein the wheel assembly has a first latch which engages the device to be transported adjacent the first wheel and a second latch which engages the device to be transported adjacent the second wheel.

6. The modular clip-on cart of claim 1 wherein the first side is opposite the second side.

7. A method of transporting a device comprising:
engaging a device to be transported on a first side with a drawbar having two elongated side members with a first end cross member, a second end cross member and a connector for engaging the device to be transported;
securing the drawbar to the device to be transported;
engaging the device to be transported on a second side with a wheel assembly module having a first wheel and a first wheel vertical connector, a second wheel and a second wheel vertical connector and a transverse member connecting the first wheel to the second wheel along an axis; and
securing the wheel assembly to the device to be transported.

8. The method of claim 7 comprising:
lifting a portion of the device to be transported by the drawbar.

9. The method of claim 7 wherein the step of engaging the device to be transported to the drawbar includes rotating a clip to secure a portion of the device to be transported against a surface of the two side members.

10. The method of claim 7 wherein the step of engaging the device to be transported to the wheel assembly includes latching the wheel assembly to secure a portion of the device to be transported against a transverse member connecting the first wheel to the second wheel along an axis.

11. A kit comprising:
a modular clip-on hand cart comprising a drawbar having two elongated side members with a first end cross member, a second end cross member and a connector for engaging a device to be transported; a wheel assembly module having a first wheel and a first wheel vertical connector, a second wheel and a second wheel vertical connector and a transverse member connecting the first wheel to the second wheel along an axis, wherein the drawbar engages the device to be transported at a first side and the wheel assembly module engages the device to be transported at a second side, and further wherein the drawbar does not directly engage the wheel assembly module; and
a steel target formed from a plate of armor grade steel having a first side and a second side, at least one target stand configurable to engage the at least one steel target, at least one transceiver positioned proximate to the at least one steel target and in wireless communication with the at least one steel target, and a plurality of vibration sensors positioned on the second side of the steel target wherein the plurality of vibration sensors detect a vibration data from a kinetic energy transferred from a projectile which impacts the first side of the steel target without penetration and wherein the plurality of sensors detect the vibration data from the second side of the steel target and further wherein the plurality of vibration sensors communicate the detected vibration data to the transceiver.

12. A modular clip-on hand cart comprising:
a drawbar means having two elongated side member means with a first end cross member means, a second end cross member means and a connector for engaging a device to be transported;
a wheel assembly module means having a first wheel and a first wheel vertical connector, a second wheel and a second wheel vertical connector and a transverse member connecting the first wheel to the second wheel along an axis,
wherein the drawbar means engages the device to be transported at a first side and the wheel assembly module means engages the device to be transported at a second side, and further wherein the drawbar means does not directly engage the wheel assembly module means.

13. The modular clip-on hand cart of claim 12 wherein the drawbar means connector is a hook means at a device engaging end of the drawbar means.

14. The modular clip-on hand cart of claim 12 wherein the first end cross member means has a pin means which secures the device to be transported against a portion of the two elongated side member means.

15. The modular clip-on hand cart of claim 12 wherein the second end cross member means has a handle means extending therefrom.

16. The modular clip-on hand cart of claim 12 wherein the wheel assembly has a first latch means which engages the device to be transported adjacent the first wheel and a second latch means which engages the device to be transported adjacent the second wheel.

17. The modular clip-on hand cart of claim 12 wherein the first side is opposite the second side.

18. A method of transporting a device comprising:
engaging a device to be transported on a first side with a drawbar means having two elongated side member means with a first end cross member means, a second end cross member means and a connector for engaging the device to be transported;
securing the drawbar means to the device to be transported;
engaging the device to be transported on a second side with a wheel assembly module means having a first wheel and a first wheel vertical connector, a second wheel and a second wheel vertical connector and a transverse member connecting the first wheel to the second wheel along an axis; and
securing the wheel assembly to the device to be transported.

19. The method of claim 18 comprising:
lifting a portion of the device to be transported by the drawbar means.

20. The method of claim 18 wherein the step of engaging the device to be transported to a drawbar means includes rotating a clip to secure a portion of the device to be transported against a surface of the two side members.

21. The method of claim 18 wherein the step of engaging the device to be transported to the wheel assembly includes latching the wheel assembly to secure a portion of the device to be transported against a transverse member connecting the first wheel to the second wheel along an axis.
